(19) United States
(12) Patent Application Publication
(10) Pub. No.: US 2004/0061379 A1
(43) Pub. Date: Apr. 1, 2004

(54) Method and system for protecting a vehicle system from a load dump

(76) Inventor: Mark A. Gohlke, Plano, TX (US)

Correspondence Address: BAKER BOTTS L.L.P., 2001 ROSS AVENUE, SUITE 600, DALLAS, TX, 75201-2980, US

(21) Appl. No.: 10/628,993

(22) Filed: Jul. 28, 2003

Related U.S. Application Data
(60) Provisional application No. 60/399,632, filed on Jul. 29, 2002.

(51) Int. Cl. H02J 1/00

(52) U.S. Cl. 307/11; 307/10.1; 340/657

(57) ABSTRACT

A method for protecting a vehicle system from a load dump includes sensing an input voltage pulse exceeding a first value and determining whether the voltage pulse is a load dump. The method includes disconnecting the system from power if the voltage pulse is a load dump and absorbing the voltage pulse if the voltage pulse is not a load dump.

### RELATED APPLICATION

This application claims the benefit of U.S. provisional application Serial No. 60/399,632, filed Jul. 29, 2002, entitled Method and System for Protecting a Display Unit from a Load Dump.

### TECHNICAL FIELD OF THE INVENTION

This invention relates generally to vehicle systems and, more particularly, to a method and system for protecting a vehicle system from a load dump.

### BACKGROUND OF THE INVENTION

During daylight hours, the driver of a vehicle is able to readily detect and recognize objects that would be difficult or impossible to detect or recognize at night. Consequently, in order to supplement the natural vision of a driver, and thus reduce the risk of accidents, night vision systems have been developed for vehicles, including automobiles sold in the consumer market. Typical night vision systems include an infrared camera unit, which gathers information regarding the scene in front of the vehicle, mounted in the grill of the vehicle and a head-up display, which projects an image derived from information provided by the camera unit onto an imaging mirror of a display unit for viewing by the driver of the vehicle. The display unit may be connected to the vehicle's power bus and thus may need protection from energy transients, such as load dumps and load switching spikes, which may otherwise damage components of the display unit.

### SUMMARY OF THE INVENTION

The present invention provides a method and system for protecting a display unit from a load dump that substantially eliminates or reduces at least some of the disadvantages and problems associated with previous methods and systems.

In accordance with a particular embodiment of the present invention, a method for protecting a vehicle system from a load dump includes sensing an input voltage pulse exceeding a first value and determining whether the voltage pulse is a load dump. The method includes disconnecting the system from power if the voltage pulse is a load dump and absorbing the voltage pulse if the voltage pulse is not a load dump.

The method may include reconnecting the system with power when the voltage pulse concludes. Determining whether the voltage pulse is a load dump may comprise measuring a time duration of the voltage pulse. Disconnecting the system from power if the voltage pulse is a load dump may comprise disconnecting the system from power if the time duration of the pulse exceeds a second value. The second value may comprise approximately seventeen milliseconds. Disconnecting the system fom power if the voltage pulse is a load dump may comprise disconnecting a display unit of an auxiliary vision system from power if the voltage pulse is a load dump. The display unit may be coupled to an auxiliary vision system of a vehicle.

In accordance with another embodiment, a method for displaying an image at a display unit comprises receiving an image from a video source coupled to the display unit and projecting the image onto a fold mirror of the display unit. The method includes reflecting the image onto an imaging mirror of the display unit for viewing by a user and sensing an input voltage pulse exceeding a first value. The method also includes determining whether the voltage pulse is a load dump and disconnecting the display unit from power if the voltage pulse is a load dump. Receiving an image from a video source may comprise directing energy from a scene towards a detector, receiving energy from a portion of the scene at each of a plurality of detector elements, converting the energy received at each detector element into information representative of the received energy and forming a visible image using the information representative of the received energy.

Technical advantages of particular embodiments of the present invention include a method and system for protecting a display unit from a load dump that avoids interference with normal operation of the display unit and avoids causing the required normal input operating voltage range to be reduced. The method and system also avoids causing undue power dissipation from a vehicle in which the display unit is operating.

The system is able to draw near zero current when power is off which avoids extraneous drain of the battery of the vehicle in which the display unit is operating. When a load dump passes through the system, instead of absorbing the pulse energy the system disconnects power from the display unit thereby allowing the display unit to ignore the pulse. This allows transient protection devices such as load spike protectors to be sized only to handle the far lower energy load switching spikes.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a diagrammatic view of a vehicle incorporating an auxiliary vision system, in accordance with an embodiment of the present invention;

FIG. 2 is a diagrammatic view of the auxiliary vision system of FIG. 1, showing in greater detail the internal structure of a camera unit and a display unit, in accordance with an embodiment of the present invention;

FIG. 3 is a diagrammatic perspective view of a display unit of an auxiliary vision system, in accordance with an embodiment of the present invention;

FIG. 4 is another diagrammatic perspective view of the display unit of FIG. 3;

FIG. 5 is a diagrammatic perspective view of a display unit with the imaging mirror and the fold mirror in a recessed, non-operational position, in accordance with an embodiment of the present invention;

FIG. 6 is a diagram illustrating protection circuitry of a display unit, in accordance with an embodiment of the present invention; and

FIG. 7 is a flowchart illustrating a method for protecting a vehicle system from a load dump, in accordance with a particular embodiment of the present invention.

### DETAILED DESCRIPTION OF THE INVENTION

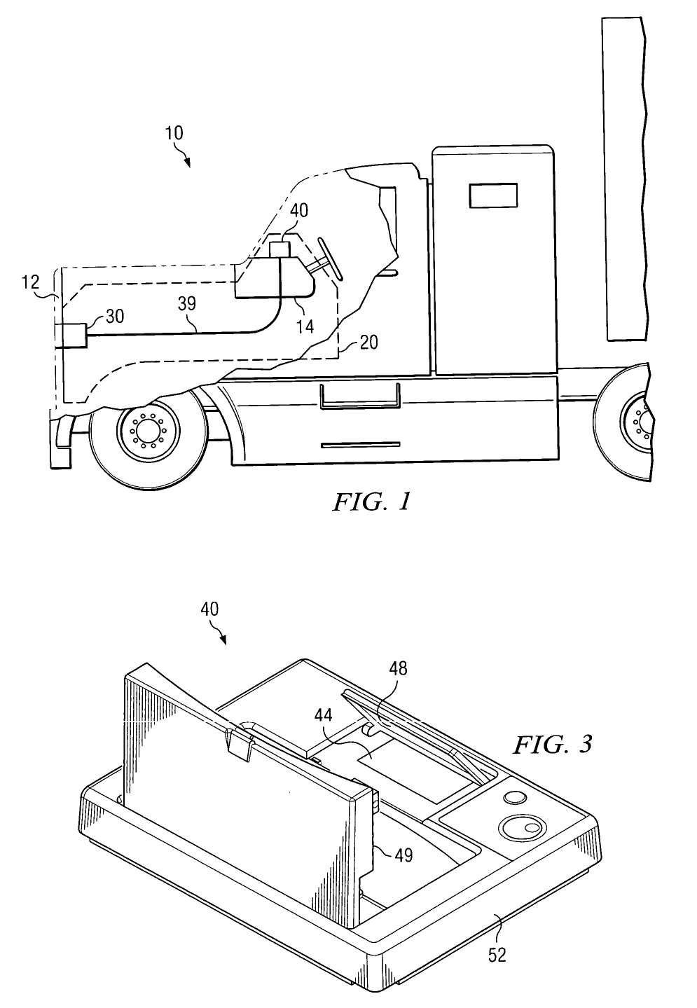

FIG. 1 is a diagrammatic view of a vehicle 10 incorporating an auxiliary vision system 20 in accordance with an embodiment of the present invention. In this embodiment, vehicle 10 is a truck; however, in other embodiments vehicle 10 may be another type of vehicle, such as a recreation vehicle or a car. The auxiliary vision system 20 includes a camera unit 30, which in the illustrated embodiment is mounted at the front of vehicle 10, in the middle of a front grill 12. The camera unit 30 is electrically coupled at 39 to a display unit 40, which is also a part of the auxiliary vision system 20. The display unit 40 is of a type that is commonly known as a head-up display (HUD).

In the illustrated embodiment, the display unit 40 is set on dashboard 14 of the vehicle 10 and can project an image for reflection by a fold mirror of display unit 40 onto an imaging mirror of display unit 40 for display to the driver or a passenger. In particular embodiments, the display unit 40 may be inverted and mounted on the ceiling of vehicle 10 in a position above the dashboard for viewing by the driver or a passenger. Display unit 40 may also be otherwise positioned Or mounted within vehicle 10.

When a driver is operating a vehicle at night, the driver's ability to see the road ahead is substantially more limited than would be case for the same section of road during daylight hours. This is particularly true in a rural area under conditions where there is little moonlight, there are no street lights, and there are no headlights of other vehicles.

One feature of auxiliary vision system 20 of FIG. 1 is the ability to provide the driver of the vehicle 10 with information above and beyond that which the driver can discern at night with the naked eye. In this regard, the camera unit 30 can detect infrared information at a distance well beyond the effective reach of the headlights of the vehicle 10. In the case of a life form such as an animal or a human, the heat signature of the life form, when presented in an infrared image derived from the camera unit 30, will usually have a significant contrast in comparison to the relatively hotter or cooler surrounding natural environment. As discussed above, this is not necessarily the case in a comparable nighttime image based on visible light.

Thus, in addition to the visible image that is directly observed by the driver through the windshield of the vehicle based on headlight illumination and any other available light, the auxiliary vision system 20 provides a separate and auxiliary image, based on infrared radiation, that is reflected onto the imaging mirror of auxiliary vision system 20 for viewing by the driver. This auxiliary image can provide a detectable representation of lifeforms or objects ahead that are not yet visible to the naked eye. Further, the auxiliary image can provide a much more striking contrast than a visible image between the lifeforms or objects and the surrounding scene. Note that the auxiliary vision system 20 may also be useful during daylight hours to supplement the view of objects seen with natural light.

Auxiliary vision system 20 may also include other components, such as an angle encoder and/or an inclinometer to provide information regarding the heading of vehicle 10, such as, for example, steering rate, inclination rate, and/or orientation. Other components may be utilized by auxiliary vision system 20 to present other types of information.

In particular embodiments, display unit 40 may be coupled to a video source other than camera unit 30 and may thus present other types of images. For example, in some embodiments the display unit may be coupled to a global positioning satellite (GPS) system, a dvd player or other component. Text messages, navigation information, dashboard information or other information or images may be displayed by display unit 40.

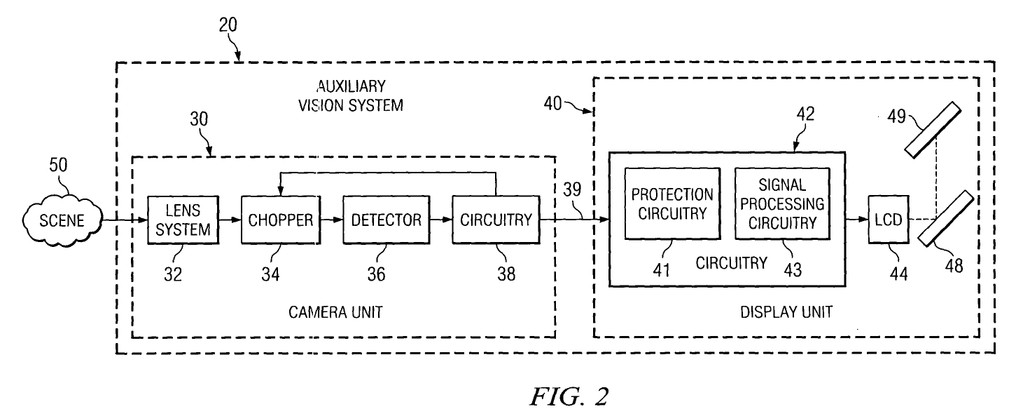

FIG. 2 is a diagrammatic view of the auxiliary vision system 20 of FIG. 1, showing in greater detail the internal structure of both the camera unit 30 and the display unit 40, in accordance with an embodiment of the present invention. More specifically, thermal radiation from a scene 50 enters the camera unit 30 and passes through a lens system 32 and a chopper 34 to a detector 36. The lens system 32 directs the incoming radiation onto an image plane of the detector 36. The chopper 34 is a rotating disk of a known type. As the chopper 34 is rotated, it modulates the incoming infrared radiation to the detector 36.

The detector 36 may be a commercially available focal plane array or staring array detector, which has a two-dimensional matrix of detector elements, where each detector element produces a respective pixel of a resulting image. In particular embodiments, detector 36 may be an uncooled pyroelectric barium strontium titanate (BST) detector, although numerous other types of detectors would also be useful in auxiliary vision system 20.

The circuitry 38 is provided to control the detector 36 and read out the images that it detects, and also to synchronize the chopper 34 to operation of the detector 36. Further, the circuitry 38 sends the information obtained from detector 36 through the electrical coupling 39 to the circuitry 42 within the display unit 40.

The circuitry 42 includes protection circuitry 41 and signal processing circuitry 43. Protection circuitry 41 operates to protect display unit 40 from energy surges, such as load switching spikes and load dumps. Protection circuitry 41 is discussed in greater detail below.

The circuitry 42 controls a liquid crystal display (LCD) 44, which in particular embodiments has a two-dimensional array of pixel elements. The display unit 40 has a horizontal to vertical aspect ratio of 3:1. Other embodiments may include a display unit having a different horizontal to vertical aspect ratio. The circuitry 42 takes successive images obtained from the detector 36 through circuitry 38 and presents these on the LCD 44. The LCD 44 may include backlighting that makes the image on LCD 44 visible at night.

This visible image is projected onto a fold mirror 48 that reflects the image so as to be directed onto imaging mirror 49, creating a virtual image for the driver. Although fold mirror 48 and imaging mirror 49 are shown diagrammatically in FIG. 2 as planar components, each may have a relatively complex curvature that is known in the art. The curvature may also give the mirrors some optical power, so that they impart a degree of magnification to the image.

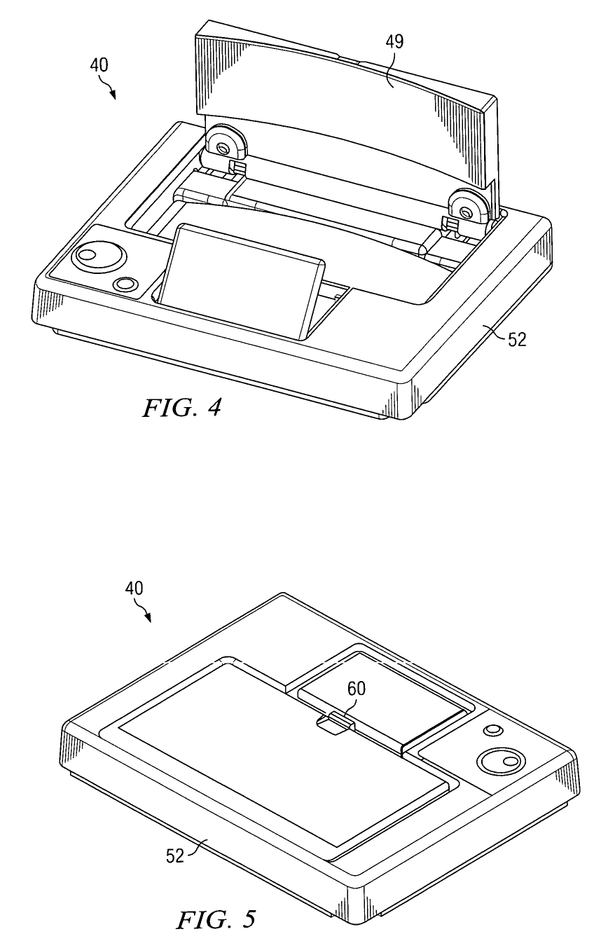

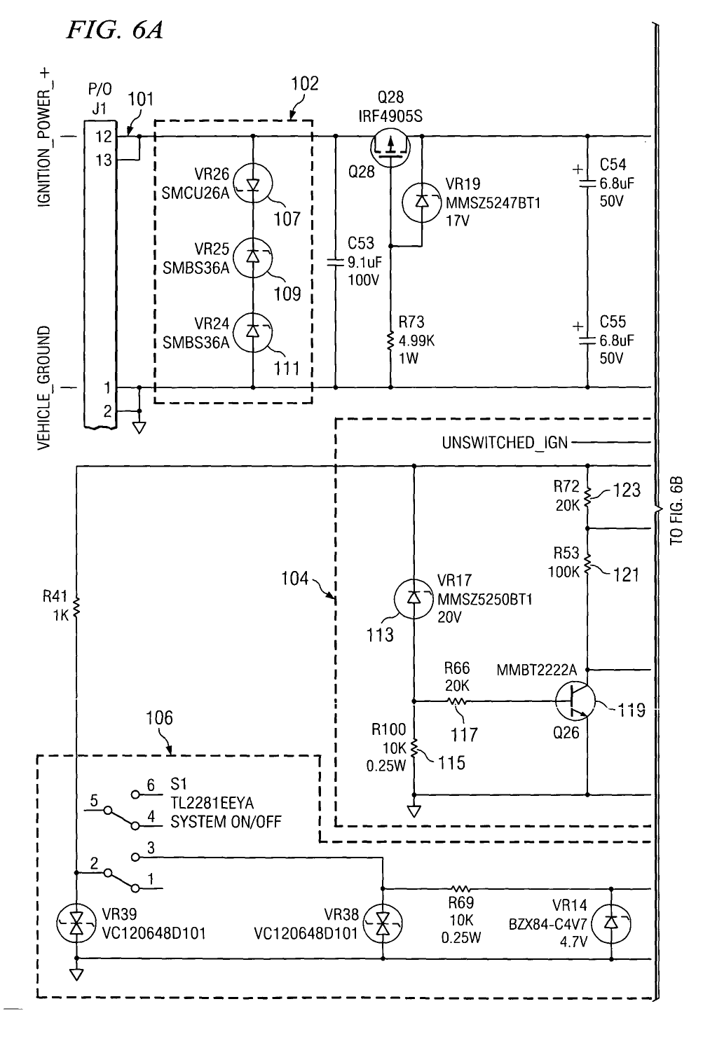

FIG. 3 is a diagrammatic perspective view of display unit 40. FIG. 4 is another diagrammatic perspective view of the display unit 40, taken from a different angle. In particular embodiments, the display unit 40 may be mounted permanently or removably on top of the dashboard of a vehicle. It may also be mounted invertedly above the dashboard, in which case the image may be inverted by display unit 40 so that it is presented optimally to the driver or a passenger. The display unit 40 may also be positioned in other ways in a vehicle or may be moved from one vehicle to another. Because of its portability, display unit 40 is sometimes referred to as a notebook HUD.

The display unit 40 has an LCD 44, a planar fold mirror 48, and an aspheric imaging mirror 49. Radiation from the LCD 44 travels upwardly to the fold mirror 48 and is reflected toward the imaging mirror 49. This radiation is then reflected by the imaging mirror 49 directly toward the eye of the driver or a passenger. The imaging mirror 49 is supported for pivotal movement relative to a housing 52 and can be pivotally positioned so that the imaging mirror 49 is in a comfortably viewable position for the driver or a passenger. The fold mirror 48 is also supported for pivotal movement.

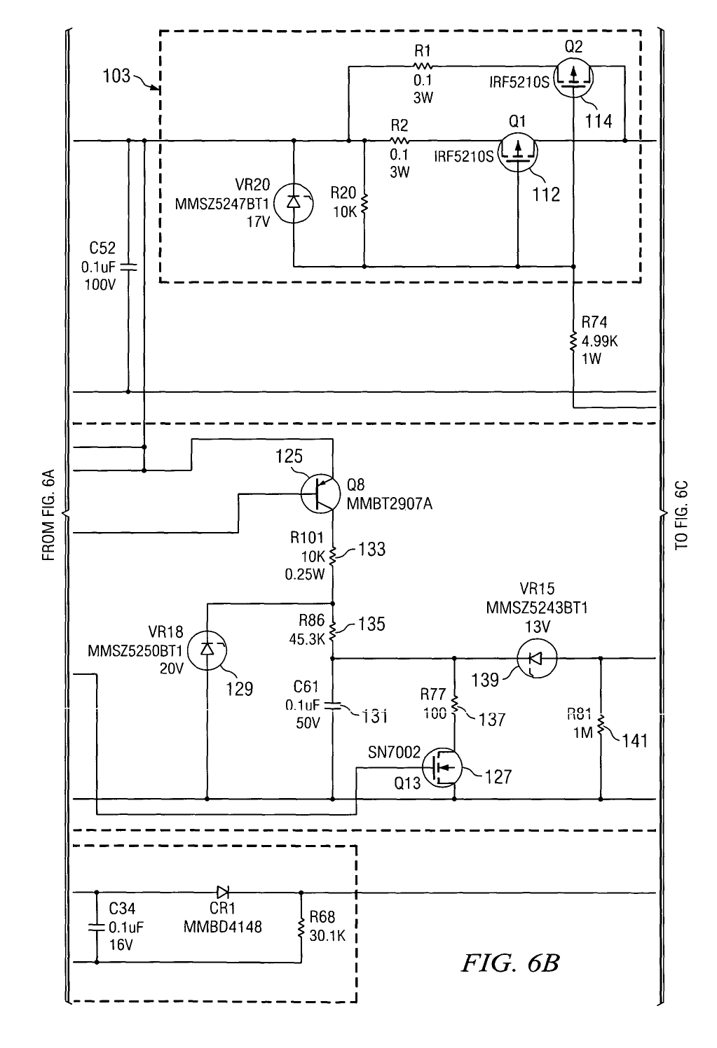

When the display unit 40 is not being used, the mirrors 48 and 49 can both be pivoted downwardly to a non-operational position in which they are both substantially horizontal. In this regard, FIG. 5 is a diagrammatic perspective view of the display unit 40, and shows the substantially horizontal positions of the mirrors 48 and 49. The ability of mirrors 48 and 49 to pivot to a substantially horizontal position when not in use allows display unit 40 to have a relatively thin profile.

The deployment of mirrors 48 and 49 begins with the release of a latch 60. When latch 60 is released, imaging mirror 49 (and the panel supporting imaging mirror 49) releases and deploys to a partially-opened position, and fold mirror 48 (and the panel supporting fold mirror 48) deploys to its full open position. The imaging mirror 49 may then be opened further to an optimum viewing angle for the driver or a passenger with no further movement of the fold mirror 48.

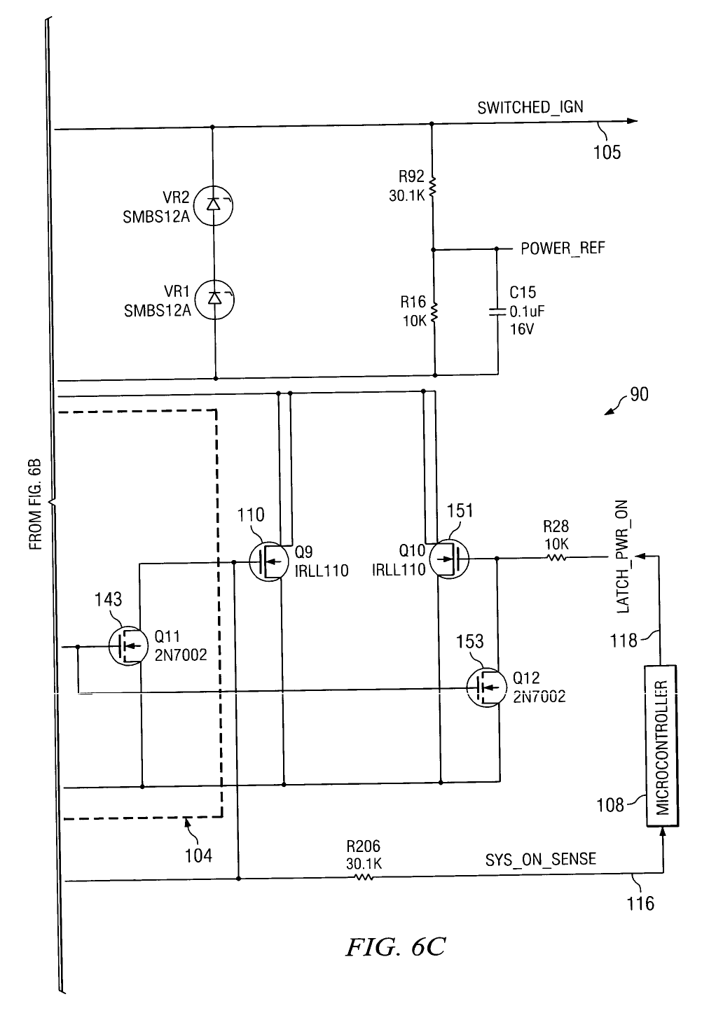

FIG. 6 illustrates protection circuitry 90, in accordance with a particular embodiment of the present invention. In particular embodiments, protection circuitry 90 may act as protection circuitry 41 of FIG. 2. Protection circuitry 90 operates to protect a vehicle system from high energy pulses such as load dumps. In particular embodiments, the vehicle system may be display unit 40 of FIGS. 1-5; however, in other embodiments protection circuitry 90 may protect other types of vehicle systems, A load dump may occur when the alternator load of a vehicle is abruptly reduced. This sudden reduction in current causes the alternator to generate a positive voltage spike. For example, a severe case load dump may be caused by disconnecting a discharged battery when the alternator is operated at rated load. The load dump transient may contain considerable electrical energy which must be safely dissipated or blocked to prevent damage to electronic components such as display unit 40.

Protection circuitry 90 also avoids reaction to power line transients called load switching spikes caused by operation of inductive accessories, such as windshield wipers. Such transients are of less energy but greater voltage than a load dump. An inductive load switching transient may be caused by solenoid, motor field, air conditioning clutch and ignition system switching. These occur during vehicle operation whenever an inductive accessory is turned off. Severity is dependent on the magnitude of switched inductive load and line impedance. Inductive load switching transients may cause component damage or may introduce logic or functional computational errors.

Protection circuitry 90 avoids interference with normal operation of the vehicle system and avoids causing the required normal input operating voltage range to be reduced. Protection circuitry 90 also avoids causing undue power dissipation from the vehicle.

Protection circuitry 90 operates when an input voltage exceeds a preset limit, beyond which the vehicle system protected by circuitry 90, such as display unit 40, would be damaged. The time duration of the voltage pulse is also measured to determine if the pulse is a load switching spike or a load dump. A pulse which is longer than a preset limit is a load dump. If the input voltage exceeds the preset value for less than the time required to classify as a load dump, then series switch 103 remains on and transient protection devices absorb the pulse, which is a load switching spike. If the input voltage exceeds the preset value for more than the time required to classify as a load dump, then series switch 103 rapidly turns off for protection. The transient protection devices will absorb the start of the pulse before series switch 103 turns off. Thus, the vehicle system protected by circuitry 90 may be protected from load switching spikes and load dumps.

Protection circuitry 90 includes load spike protector 102, pulse detector 104, on/off control 106, microcontroller 108 and series switch 103. Protection circuitry 90 receives power from the vehicle at power input 101. Load spike protector 102 includes transorbs 107, 109 and 111. Load spike protector 102 absorbs and protects the vehicle system from a load switching spike.

When a user desires to operate the vehicle system protected by circuitry 90, such as display unit 40, the user activates an on/off mechanism on the system. At such time, on/off control 106 transmits a request to microcontroller 108 through microcontroller input 116 that the user desires to turn on the vehicle system. Microcontroller 108 turns on the system through microcontroller output 118.

Series switch 103 includes switches 112 and 114 which are on when the vehicle system is in operation. During such operation, power passes through protection circuitry 90 to other circuitry of the vehicle system through power output 105. When a load dump is detected by pulse detector 104 further discussed below, series switch 103 is turned off so that power does not pass through power output 105. In particular embodiments, switches 112 and 114 are hexagonal field effect transistor (HEXFET) p-channel Power metal oxide silicon field effect transistors (MOSFETs) with low forward on-resistance to reduce power dissipation.

Pulse detector 104 operates to measure the time duration of a voltage pulse to determine if the voltage pulse is a load dump. If the time duration of the voltage pulse exceeds a preset value, then switch 110 is activated by pulse detector 104. Such activation of switch 110 turns series switch 103 off thus disconnecting the power from the vehicle system and thereby protecting the system from the load dump. Pulse detector 104 includes zener diode 113, resistors 115 and 117, and transistor 119. Transistor 119 is activated by a current through resistor 115. A current flows through resistor 115 when a voltage is greater than a certain amount (for example, 20 volts in particular embodiments) thus allowing current to flow through diode 113.

Forward biasing the gate-emitter junction of npn transistor 119 is achieved by the positive voltage developed at the node between resistors 115 and 117 in response to current flow through diode 113. As ground is applied to the collector of transistor 119, which is connected to the gate of n-channel field effect transistor (FET) 127, n-channel FET 127 is disabled, removing ground potential from the cathode of zener diode 139. Transistor 119, now active, allows current to flow through resistors 123 and 121 to ground, forward biasing the gate-emitter junction of pnp transistor 125 and thus conducting current through resistors 133 and 135 and capacitor 131 to ground. The voltage established across capacitor 131 is a function of time and therefore can be used to determine when a load dump incident is present. The time constant is established by the resistances of resistors 133 & 135 along with the capacitance presented by capacitor 131 (approximately 5.5 milliseconds in particular embodiments). As the voltage pulse established on capacitor 131 exceeds a certain predetermined expected value of about thirteen volts in particular embodiments, zener diode 139 conducts current through resistor 141 to ground, thus establishing a positive voltage at the gate of n-channel FET 143. The positive voltage at the gate of n-channel FET 143 activates n-channel FET 143, pulling down the gate of n-channel FET 110, which is normally active due to the on/off control 106 being in the “on” position and providing a positive voltage at the gate of n-channel FET 110. Once n-channel FET 110 is deactivated, ground is no longer available to the gates of p-channel power MOSFETs 112 and 114 of series switch 103, thus p-channel power MOSFETs 112 and 114 are deactivated and power does not reach output 105.

The positive voltage appearing at the gate of n-channel FET 143 is also connected to the gate of n-channel FET 153, which is now activated, pulling the gate of n-channel FET 151 to ground potential thereby deactivating FET 151. This sequence of events also eliminates a parallel drive path for series switch 103 by preventing the requited ground potential from reaching either p-channel FET 112 or 114 of series switch 103.

When the voltage disturbance is removed or falls below the voltage required to conduct any appreciable current through zener diode 113, the sequence reverses itself and the voltage appearing across capacitor 131 is removed through resistor 137 as n-channel FET 127 is activated when npn transistor 119 and pnp transistor 125 are deactivated. The sequence may then be ready to be repeated again as necessary.

The preset value of the duration of the voltage pulse which determines whether the voltage pulse is a load dump may vary in different embodiments. For example, in some embodiments such duration may be approximately 17 milliseconds. When the voltage pulse is gone, power is reconnected through the vehicle system, such as display unit 40, automatically through the inherent operation of protection circuitry 90, as pulse detector 104 will no longer detect a voltage pulse.

Protection circuitry 90 is able to draw near zero current when power is off. This avoids extraneous drain of the battery of the vehicle in which the vehicle system is operating.

As discussed above, when a load dump passes through protection circuitry 90, instead of absorbing the pulse protection circuitry 90 disconnects power through the vehicle system thereby allowing the vehicle system to ignore the pulse. This allows transient protection devices such as load spike protector 102 to be sized only to handle the far lower-energy load switching spikes. The low on resistance of protection circuitry 90 avoids a large voltage drop which would cause the vehicle system to be unable to meet the specified range of input voltages for normal operation.

Embodiments of the present invention may include protection circuitry designed to protect a system, such as a display unit, from various transient, noise and electrostatic characteristics encountered in various vehicle operations. For example particular embodiments may protect a display unit operating within a 12-volt vehicle. Typical 12-volt vehicle transient voltage characteristics may include the following:

| | | Source | Rise | | |
|---|---|---|---|---|---|
| Lines | Type | (ohms) | (μs) | Open Circuit | Repetition |
| Power | Load Dump | 0.4 | 100 | 14 + 86e^{(-t/0.4)} | 5 Pulses |
| | | | | | 10 s int. |
| I/O | Inductive | 20 | 1 | 14 ± 600e^{(-t/0.001)} | 10 Pulses at |
| | Switching | | | | 1 s int. |

Other embodiments of the present invention may include protection circuitry having different types of components or components with different characteristics or thresholds than those of protection circuitry 90 in order to protect a vehicle system from various energy pulses in a vehicle. For example, while particular operating characteristics of certain components of protection circuitry 90 are illustrated, it should be understood that other embodiments may include components having different operating characteristics.

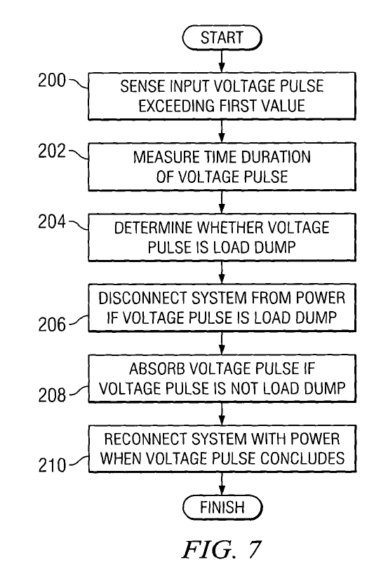

FIG. 7 is a flowchart illustrating a method for protecting a vehicle system from a load dump, in accordance with a particular embodiment of the present invention. The vehicle system may be a display unit of an auxiliary vision system of the vehicle. The method begins at step 200 where an input voltage exceeding a first value is sensed. In particular embodiments, the first value may be approximately twenty volts. The input voltage may be sensed by a pulse detector comprising a number of resistors, diodes and capacitors. At step 202, a time duration of the voltage pulse is measured. At step 204, it is determined whether the voltage pulse is a load dump. A voltage pulse may be a load dump if the measured time duration is greater than a certain value, for example seventeen milliseconds.

If it is determined that the voltage pulse is a load dump, then at step 206 power is disconnected from the vehicle system. At step 210 power is reconnected to the system when the voltage pulse concludes. If the voltage pulse is not a load dump then the voltage pulse is considered a load switching spike, and the voltage pulse is absorbed.

Some of the steps illustrated in FIG. 7 may be combined, modified or deleted where appropriate, and additional steps may also be added to the flowchart. Additionally, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within protection circuitry 90, these elements may be combined, rearranged or positioned in order to accommodate particular routing architectures or needs. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

What is claimed is:

1. A method for protecting a vehicle system from a load dump, comprising:
sensing an input voltage pulse exceeding a first value;
determining whether the voltage pulse is a load dump;
disconnecting the system from power if the voltage pulse is a load dump; and
absorbing the voltage pulse if the voltage pulse is not a load dump.

2. The method of claim 1, further comprising reconnecting the system with power when the voltage pulse concludes.

3. The method of claim 1, wherein determining whether the voltage pulse is a load dump comprises measuring a time duration of the voltage pulse.

4. The method of claim 3, wherein disconnecting the system from power if the voltage pulse is a load dump comprises disconnecting the system from power if the time duration of the pulse exceeds a second value.

5. The method of claim 4, wherein the second value comprises approximately seventeen milliseconds.

6. The method of claim 1, wherein disconnecting the system from power if the voltage pulse is a load dump comprises disconnecting a display unit of an auxiliary vision system from power if the voltage pulse is a load dump.

7. The method of claim 6, wherein the display unit is coupled to an auxiliary vision system of a vehicle.

8. The method of claim 6, wherein the display unit is coupled to a global positioning satellite (GPS) system of a vehicle.

9. A method for displaying an image at a display unit, comprising:
receiving an image from a video source coupled to the display unit;
projecting the image onto a fold mirror of the display unit;
reflecting the image onto an imaging mirror of the display unit for viewing by a user;
sensing an input voltage pulse exceeding a first value;
determining whether the voltage pulse is a load dump; and
disconnecting the display unit from power if the voltage pulse is a load dump.

10. The method of claim 9, further comprising reconnecting the display unit with power when the voltage pulse concludes.

11. The method of claim 9, wherein determining whether the voltage pulse is a load dump comprises measuring the time duration of the voltage pulse.

12. The method of claim 9, wherein disconnecting the display unit from power if the voltage pulse is a load dump comprises disconnecting the display unit from power if the time duration of the pulse exceeds a second value.

13. The method of claim 12, wherein the second value comprises approximately seventeen milliseconds.

14. The method of claim 9, wherein receiving an image from a video source comprises receiving an image from a camera unit of an auxiliary vision system of a vehicle.

15. The method of claim 9, wherein receiving an image from a video source comprises:
directing energy from a scene towards a detector;
receiving energy from a portion of the scene at each of a plurality of detector elements;
converting the energy received at each detector element into information representative of the received energy; and
forming a visible image using the information representative of the received energy.

16. A protection circuitry system for protecting a vehicle system from a load dump, comprising:
a pulse detector operable to:
sense an input voltage pulse exceeding a first value; and
determine whether the voltage pulse is a load dump;
a series switch coupled to the pulse detector, the series switch operable to disconnect the system from power if the voltage pulse is a load dump; and
a load spike protector coupled to the pulse detector, the load spike protector operable to absorb the voltage pulse if the voltage pulse is not a load dump.

17. The circuitry system of claim 16, wherein the series switch is further operable to reconnect the system with power when the voltage pulse concludes.

18. The circuitry system of claim 16, wherein a pulse detector operable to determine whether the voltage pulse is a load dump comprises a pulse detector operable to measure a time duration of the voltage pulse.

19. The circuitry system of claim 18, wherein disconnecting the system from power if the voltage pulse is a load dump comprises disconnecting the system from power if the time duration of the pulse exceeds a second value.

20. The circuitry system of claim 19, wherein the second value comprises approximately seventeen milliseconds.

21. The circuitry system of claim 16, wherein disconnecting the system from power if the voltage pulse is a load dump comprises disconnecting a display unit of an auxiliary vision system from power if the voltage pulse is a load dump.

22. The circuitry system of claim 21, wherein the display unit is coupled to an auxiliary vision system of a vehicle.

23. The circuitry system of claim 21, wherein the display unit is coupled to a global positioning satellite (GPS) system of a vehicle.
